(19) United States
(12) Patent Application Publication
(10) Pub. No.: US 2015/0290999 A1
(43) Pub. Date: Oct. 15, 2015

(54) AIR CONDITIONING SYSTEM FOR AUTOMOBILE WITH MULTIPLE CONTROL DAMPERS

(71) Applicant: Halla Visteon Climate Control Corp., Daejeon (KR)

(72) Inventors: Ralph Wiesmann, Euskirchen (DE); Torsten Klein, Koln (DE); Antonio Marques, Koenigswinter (DE); Navid Durrani, Kerpen (DE)

(21) Appl. No.: 14/682,135

(22) Filed: Apr. 9, 2015

(30) Foreign Application Priority Data
Apr. 9, 2014 (DE) 102014105035.5

(51) Int. Cl. B60H 1/00

(52) U.S. Cl. CPC B60H 1/00057; B60H 1/00064; B60H 2001/3485

(57) ABSTRACT

The invention relates to a motor vehicle air conditioning system having a plurality of control dampers, the control dampers being designed as at least one cold air damper and at least one warm air damper for controlling a cold air path and a warm air path, which system is characterized in that a passage for a partial air flow can be formed between the control dampers depending on the damper position, and in that the passage forms additional air flow resistance for the cold air flow, thereby increasing the linearity of flow control of the cold air flow and the warm air flow.

### CROSS-REFERENCE TO RELATED APPLICATIONS

This application claims priority to German Patent Application No. 10 2014 105035.5, filed on Apr. 9, 2014, the disclosure of which is incorporated herein by reference in its entirety.

### FIELD OF THE INVENTION

The invention relates to a motor vehicle air conditioning system having a plurality of control dampers for generating a warm air flow and a cold air flow within the air conditioning system. The structural design and the positioning of the control dampers relative to one another result in an improvement in the linearity of damper control in the temperature control and ventilation of motor vehicle passenger compartments.

### BACKGROUND OF THE INVENTION

It is known in the prior art to use air conditioning systems to control the temperature inside motor vehicles, particularly to heat, cool and ventilate said vehicles, by conducting the air flows into different regions of the vehicle. The air conditioning system is supplied with fresh air from outside the vehicle and/or with recirculated air from inside the passenger compartment. The air flow to be treated by the air conditioning system is first dehumidified by cooling, after which at least a partial air flow is reheated. By mixing the cold air flow with the warm air flow, the desired temperature can be adjusted and then distributed within the vehicle passenger compartment.

In selecting the temperature and the airflow rate, the driver requires sufficient linearity or proportionality, meaning that adjustment based on the scale of the temperature selection device should be transferred in a linear or proportional manner to the temperature of the air that is delivered to the vehicle passenger compartment. The flow path of the warm air flow through the heating heat exchanger has greater flow resistance than the flow path of the cold air flow of air that has been cooled but not reheated. This circumstance and the associated problems with linearity of the control dampers resulting from the different flow resistances are known in the prior art.

To solve this problem, devices are known in the prior art which have one or more control dampers that determine the air flow distribution through the air conditioning system.

For example, DE 101 47 112 A1 discloses a device for the temperature control and ventilation of motor vehicles, said device comprising a control damper which has two damper blades. This control damper is mounted pivotably in a housing, and one flat side of the control damper is equipped with a flow guide element. An additional flow cross-section through which the air can flow is thus formed between the flat side and the flow guide element.

DE 196 31 371 A1 discloses a heating or air conditioning system for a motor vehicle, which is designed with two air outlet channels arranged side by side and assigned a common damper which controls the air flow rate and/or temperature. An additional possibility for adjusting air flow rate and/or temperature is provided by equipping the damper with a variable flow deflecting strip along an edge that extends perpendicular to the air flow direction. This flow deflecting strip extends over part of the edge length and over both air outlet channels.

Also known in the prior art are generic air treatment devices in which at least two control dampers are used for flow distribution, a cold air damper for controlling the flow of air through a cold air path and a warm air damper for controlling the flow of air through a heating device along a warm air path.

A control damper in simplified form is designed as a flat damper disk, the size and shape of which match those of the opening in the flow path, enabling the disk to seal the opening in an air tight manner. Thus the damper disk ideally forms a plane which, when the control damper is fully closed, coincides with the plane of the opening in the flow path. In addition, a rotational axis is located within the plane of the damper disk. This rotational axis generally extends centrally and symmetrically through the center of the damper disk, in order to minimize the torque required for actuation.

With this configuration, when the control damper is fully open, one half of the damper, a so-called damper blade, points in the direction of the air flow while the other damper blade points in the opposite direction. The opened damper disk thus divides the opening in the flow path into two regions, also referred to as passages.

KR 10-2006-0028202 A also concerns a control damper mechanism for motor vehicle air conditioning systems, for precisely controlling the opening angle. According to this document, the control dampers are connected via toothed belts or the like to a common drive device, so that the opening angles of the individual control dampers are always in a fixed relationship with one another.

Furthermore, KR 10-2010-0126938 A describes a mixing damper for an air conditioning system, which is designed specifically for decreasing the dimensions of the air conditioning system housing. The mixing dampers of the warm air path and the cold air path are embodied as butterfly dampers, which are connected to one another via a common control lever and are moved together. Thus these mixing dampers are also always in a fixed relationship with one another.

It is known that the linearity of damper control can be improved to some extent by providing the cold air path of the air conditioning system with additional sources of air flow resistance, to compensate for the greater flow resistance through the heating heat exchanger in the warm air path. This is achieved by using means that reduce the flow cross-section, for example, V-shaped openings or flow guide elements. It is a disadvantage that these additional sources of resistance in the cold air path decrease the flow of air through the air conditioning system and the efficiency of the system due to increased energy consumption and the use of additional technical means.

### SUMMARY OF THE INVENTION

The object of the invention is to improve the linearity of damper control of the motor vehicle air conditioning system without diminishing the performance of the system overall. The solution should be technically simple and cost-effectively implementable.

The object is attained by a subject matter having the features according to patent claim 1. Developments are specified in the dependent claims.

The object of the invention is attained by a motor vehicle air conditioning system having a plurality of control dampers, the control dampers being embodied as at least one cold air damper and at least one warm air damper for controlling a cold air path and a warm air path. The control dampers are embodied and positioned in such a way that, depending on the damper position, a passage for a partial air flow can be formed between the control dampers. This passage forms an additional source of air flow resistance for the cold air flow, thereby increasing the linearity of flow control of the cold air flow and the warm air flow.

The cold air damper is preferably designed as linearly actuable, whereas the warm air damper is preferably designed as non-linearly or linearly actuable.

Proceeding from symmetrically designed control dampers according to the prior art as flat damper disks, with the rotational axis extending through the center of and within the damper disk, a preferred and simple embodiment of the invention is produced by arranging the rotational axis of the cold air damper and/or the warm air damper eccentrically and asymmetrically within the plane of the damper disk. The asymmetrical embodiment of the rotational axis of the control damper is produced by displacing the rotational axis eccentrically and parallel within the plane of the damper disk.

As an alternative to this embodiment, a variant can be advantageously achieved in which the cold air damper and/or the warm air damper have/has a rotational axis arranged outside the plane of the damper disk. This embodiment is characterized by a parallel displacement of the rotational axis to the area outside the plane of the damper disk, but centered with the damper disk. This means that the rotational axis continues to extend parallel with the plane of the damper disk and that the projection of the rotational axis continues to extend through the center point of the damper disk.

A particularly functional embodiment of the invention results from an arrangement of the rotational axis of the cold air damper eccentrically to and coplanar with the damper disk and the rotational axis of the warm air damper centrally to and outside the plane of the damper disk. The asymmetrical design of the rotational axis of the cold air damper results from an eccentric parallel displacement of the rotational axis within the plane of the damper disk, whereas the asymmetrical embodiment of the rotational axis of the warm air damper is characterized by a parallel displacement of the rotational axis to the area outside the plane of the damper disk, but centered with the damper disk.

In a particularly preferred embodiment of the invention, the cold air damper and the warm air damper interact with one another through an asymmetrical configuration of their rotational axes such that the air resistance in the passage is at a maximum when the motor vehicle air conditioning system is in the 50% warm setting, thereby increasing the linearity of flow control.

This embodiment adheres to the concept of the invention, according to which the half-opened cold air damper combined with the fully opened warm air damper places a relevant amount of resistance, corresponding to the resistance of the heating heat exchanger, in the path of the cold air flow, without generating additional pressure losses when the cold air damper is fully opened. In this embodiment, when the cold air damper is half-opened, there should be disproportionately more flow resistance in the cold air path than in the two passages above and below the cold air damper alone.

To achieve this, the warm air damper is attached higher in the air conditioning system housing, in other words closer to the evaporator and to the cold air damper. In addition, its rotational axis does not lie directly within the plane of the damper disk, and is instead likewise displaced toward the evaporator and the cold air damper. The eccentrically positioned rotational axis of the cold air damper is likewise displaced closer to the evaporator, so that the decrease in pressure over this damper when it is in the fully opened position does not change. However, in the half-opened position the upper passage is narrower than the lower passage, and therefore the decrease in pressure in the upper passage is greater than in the lower passage.

The demand for compensation of the flow resistance in the cold air path relative to that of the warm air path in the half-opened position is met by selecting the positioning of the two dampers relative to one another and to the housing such that the passage for the partial air flow between the two control dampers is embodied as particularly narrow and therefore as having significant additional flow resistance. This additional flow resistance impedes particularly the cold air path through the lower passage of the cold air damper and the warm air path through the upper passage of the warm air damper. However, by attaching the warm air damper by way of suspension, with its rotational axis not directly within the plane of the damper disk, the upper passage of the warm air damper is made smaller as compared with the lower passage in the opening. Thus the majority of the warm air flows through the lower passage of the warm air damper and therefore is not affected by the narrowing of the passage between the two control dampers. As a result, the linearity of damper control is improved, without introducing an additional decrease in pressure in the warm air path or an additional constant resistance into the cold air path.

### BRIEF DESCRIPTION OF THE DRAWINGS

Additional details, features and advantages of embodiments of the invention are presented in the following description of variants, with reference to the attached set of drawings. The drawings show:

FIG. 1: an air conditioning system with two control dampers, according to the prior art,

FIG. 2: an air conditioning system with two control dampers and a 50% warm setting, according to the prior art,

FIG. 3: an embodiment of an air conditioning system with improved linearity,

FIG. 4a: a control damper according to the prior art,

FIG. 4b: a control damper with an eccentric rotational axis,

FIG. 4c: a control damper with its rotational axis outside the plane of the damper disk,

FIG. 4d: a control damper with an eccentric rotational axis outside the plane of the damper disk,

FIG. 5: an embodiment of a motor vehicle air conditioning system with flow paths,

FIG. 6a: a resistance model of a motor vehicle air conditioning system,

FIG. 6b: a simulation model of flow resistances and

FIG. 6c: a simulation model indicating relative distances.

### DETAILED DESCRIPTION OF EXEMPLARY EMBODIMENTS OF THE INVENTION

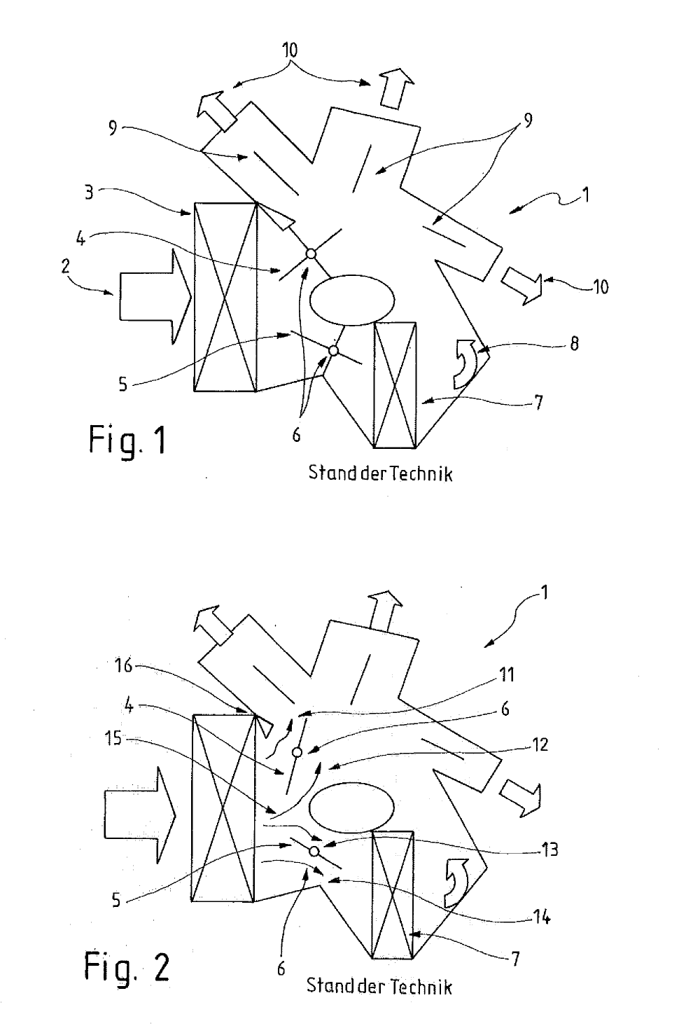

FIG. 1 is a diagram of a cross-section of a motor vehicle air conditioning system 1 having two control dampers 4, 5, according to the prior art, with an air flow 2 to be treated in this embodiment flowing in through an evaporator 3. The control dampers 4, 5 are designed as a cold air damper 4 and a warm air damper 5, each having a rotational axis 6 perpendicular to the plane of the drawing. The control dampers 4, 5 are shown in both the fully opened and the fully closed state. Part of the air flow 2 to be treated flows through the cold air damper 4 and forms a cold air flow. The other part of the air flow 2 to be treated flows through the warm air damper 5 and through a heating heat exchanger 7, located downstream of the warm air damper 5. The part of the air flow 2 to be treated that forms a warm air flow 8 encounters flow resistance in the heating heat exchanger 7, which resistance acts against the linearity of control of the control dampers 4, 5.

After passing through the heating heat exchanger 7, the warm air flow 8 moves upward and is combined with the cold air flow which passes through the cold air damper 4. Depending on the position of the control dampers 4, 5, the warm air flow 8 and the cold air flow produce an air flow 10 having the desired temperature, which is ultimately distributed via air outlet dampers 9 to air outlets, and is blown via the respective fresh air jets into the vehicle passenger compartment.

FIG. 2 shows a schematic illustration of a cross-section of the air conditioning system 1 having the two control dampers 4, 5 according to the prior art, in which the position of the two control dampers 4, 5 corresponds to a 50% warm setting. In this control damper position, which corresponds to a frequently selected temperature setting, the cold air damper 4 is in a half-opened position and the warm air damper 5 is in a fully opened position.

The diagram also indicates the air flow paths that lead through the openings of the two control dampers 4, 5. The configuration of the control damper 4, 5 according to the prior art provides for the rotational axis 6 which is perpendicular to the plane of the drawing. Thus each of the opened control dampers 4, 5 divides the air flow into two partial flows, which are equal in size if rotational axis 6 is designed in a central, centered position within the control dampers 4, 5. FIG. 2 shows cold air passages 11, 12 or an upper passage 11 of the air flow through the cold air damper 4, a lower passage 12 through the cold air damper 4 and an upper passage 13 and a lower passage 14 through the warm air damper 5.

In the 50% warm setting shown, the cold air path leads through the passages 11, 12 and a passage 15 between the cold air damper 4 and the warm air damper 5, which present a certain degree of resistance to the air flow. If linearity is insufficient in this case because the resistance of the warm air flow 8 through the heating heat exchanger 7 is even greater, the dimensions of a baffle 16 for narrowing the cross-section of the cold air damper 4 may be increased. However, a further reduction of the flow cross-section of the cold air passages 11 and 12 will also reduce the overall flow of air through the air conditioning system 1.

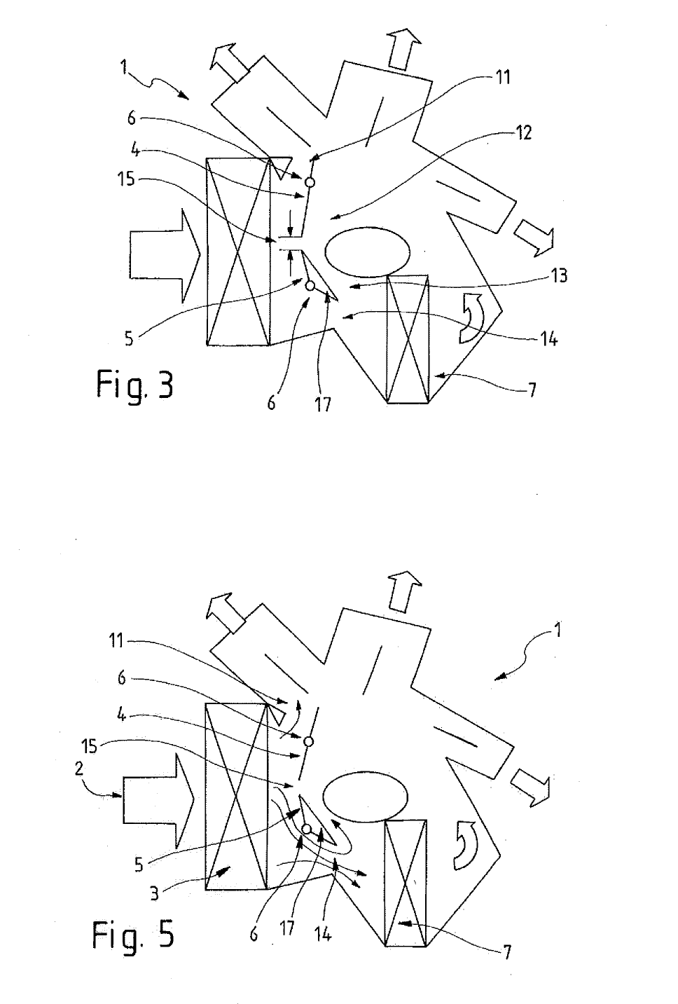

FIG. 3 shows an embodiment of the motor vehicle the air conditioning system 1 according to the invention with increased linearity at a 50% warm setting of the control dampers 4, 5. In the embodiment shown, both the axial mounting of the cold air damper 4 in the housing and the rotational axis 6 of the cold air damper 4 are positioned higher and eccentrically. Thus the lower passage 12 through the cold air damper 4 is longer and the upper passage 11 through the cold air damper 4 is narrowed. A further improvement relates to the warm air damper 5, the rotational axis 6 of which is located outside a plane of a damper disk 17, in other words, a certain distance upstream thereof. The result of these two optimization measures is a reduction in the cross-section of the passage 15 between the cold air damper 4 and the warm air damper 5.

The change in the positioning of the control dampers 4, 5 results in a narrowing of both the upper passage 11 through the cold air damper 4 and the passage 15 between the cold air damper 4 and the warm air damper 5, which substantially increases the flow resistance of the entire cold air path. At the same time, the novel suspension of the warm air damper 5 enlarges the lower passage 14 through the warm air damper 5. The two measures thus result in an increase in the air flow through the heating heat exchanger 7 and therefore to an increase in linearity.

Additional variants not shown here provide for combining the various embodiments of the rotational axes 6 differently with the control dampers 4, 5, making additional combinations of the design of the rotational axes 6 with different positions of the control dampers 4, 5 possible. Thus it is possible to design the passage 15 between the cold air damper 4 and the warm air damper 5 in the 50% warm setting as having a desired flow resistance, in accordance with the use profile.

According to the concept of the invention, the control dampers 4, 5 are arranged such that, in the 50% warm setting, the lower end of the cold air damper 4 and the upper end of the warm air damper 5 are positioned so close to one another that they form the passage 15 between the cold air damper 4 and the warm air damper 5 that reduces the flow cross-section. This affects the flow of the air through the lower passage 12 through the cold air damper 4 and the flow of the air through the upper passage 13 through the warm air damper 5.

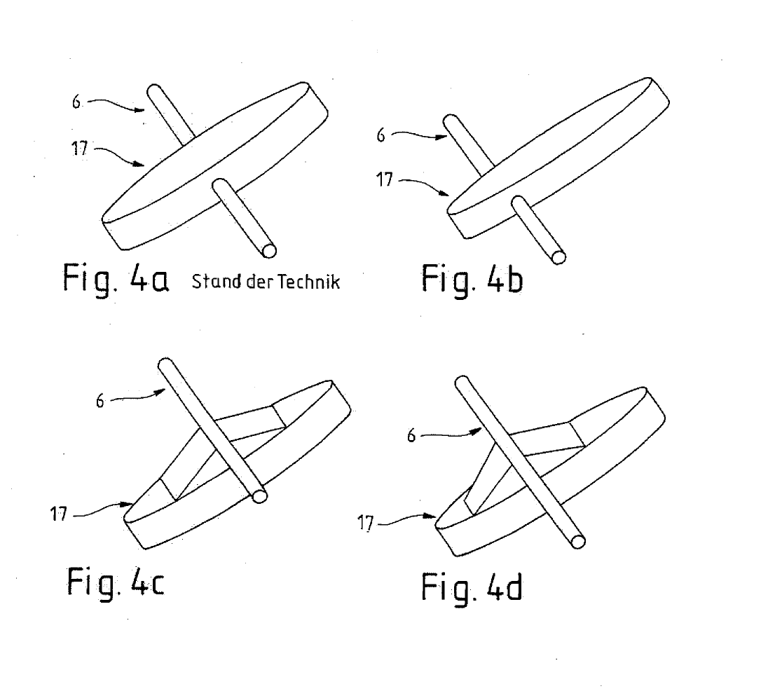

FIGS. 4a through 4d show various embodiments of the control dampers 4, 5.

FIG. 4a shows a control damper according to the prior art having the damper disk 17 with a circular shape and the rotational axis 6 designed as coplanar with the damper disk 17 and as extending through the center point of the damper disk 17,

According to an embodiment of the invention, which is illustrated in FIG. 4b, shows a control damper, the eccentric rotational axis 6 of which is designed as coplanar with the damper disk 17 but does not extend through the center point of the damper disk 17. As a result of the parallel displacement of the rotational axis 6 within the plane of the damper disk 17, when the control damper is open, two passages having openings of different sizes are formed.

FIG. 4c shows the control damper, the rotational axis 6 of which is formed outside the plane of the damper disk 17. However, a perpendicular projection of the rotational axis 6 on the damper disk 17 still extends through the center point of the damper disk 17. The greater the parallel displacement of the rotational axis 6 from the plane of the damper disk 17, the greater the difference between the openings of the passages when the control damper is open.

Finally, FIG. 4d shows the control damper, the rotational axis 6 of which is displaced in parallel both outside the center point of damper disk 17 and also outside the plane of the damper disk 17. In this variant, the difference between the areas of the passages when the control damper 4, 5 is opened according to FIGS. 3 and 5 can be determined by the distance between the rotational axis 6 and the plane of the damper disk 17, and by the lateral displacement of the rotational axis 6 within this plane. In a further variant not shown here, the rotational axis 6 is tilted in relation to the plane of the damper disk 17.

FIG. 5 shows a cross-section of the motor vehicle the air conditioning system 1 with flow paths. The rotational axis 6 of the warm air damper 5 is formed outside the plane of the damper disk 17, whereas the cold air damper 4 is in a conventional, that is, planar design. However, this generalized arrangement is based on the 50% warm setting of the control dampers 4,5. In alternative variants, it is also provided for the rotational axis 6 of the cold air damper 4 to be formed outside the plane of the damper disk 17.

The resulting air flows in the motor vehicle the air conditioning system 1 are indicated by arrows. In the first approach, a large proportion of the air flow 2 to be treated flows out of the evaporator 3 through the lower passage 14 through the warm air damper 5 in the direction of the heating heat exchanger 7. Only a small portion of the air that flows through the lower passage 14 through the warm air damper 5 is deflected upward and combines with the remaining air flow that flows through the upper passage 11 through the cold air damper 4. According to this embodiment, the flow of the air through the passage 15 between the cold air damper 4 and the warm air damper 5 is negligible.

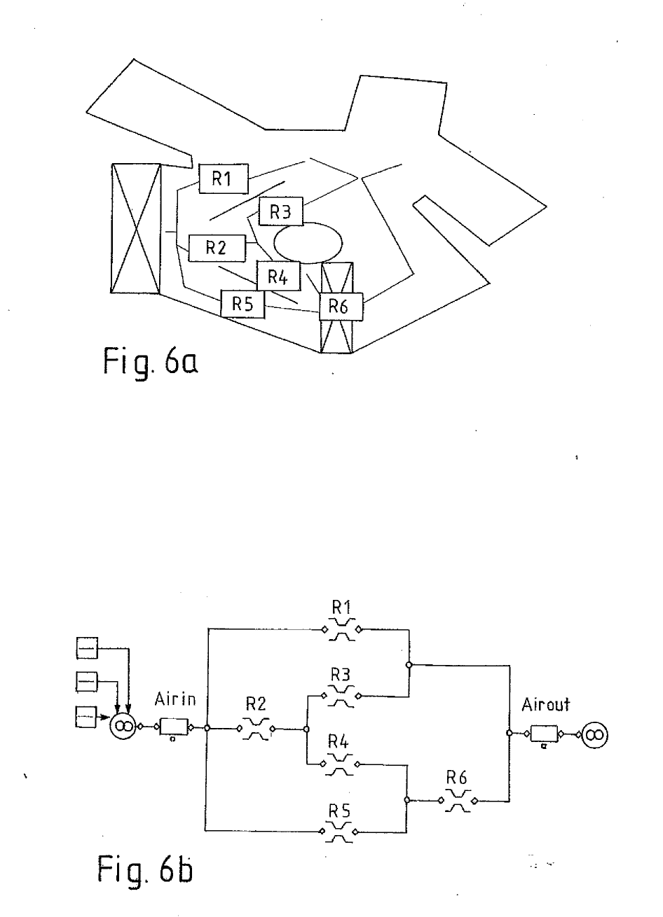

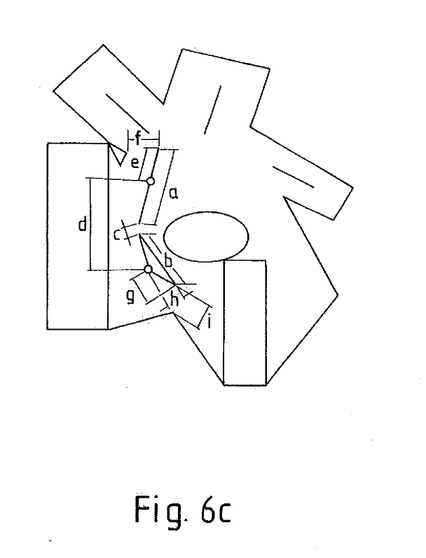

FIG. 6a shows the geometry in question of the motor vehicle air conditioning system 1 as a resistance model, in which the various flow paths are represented as unidimensional connecting lines. All significant points of resistance to the air flows are represented by resistance symbols, denoted as R1 to R5. The resistance point R6 through the heating heat exchanger 7 is added as an additional flow resistance source.

Similarly to an electric switching circuit, a branched flow of gas over predefined flow resistance points can be simulated by a computer model, as indicated symbolically in FIG. 6b. Since the gas flows through tubes, and thus advances unidimensionally in simple terms, the simulation is characterized as a unidimensional flow resistance model. By varying individual flow resistance values, various resistance combinations resulting from different control damper configurations, for example, can be compared with one another.

In this model, the “air in” element, or air intake element, represents a small infeed element with low resistance, and the “air out” element, or air outlet element, represents a similar outlet. The flow of air through the infeed element is defined as X l/s. Resistances R1 to R6 result from the respective drop in pressure Δp and the force of the air flow results according to R=c*Δp/l², in which the constant c comprises, for example, the properties of the flowing air, for example, its viscosity.

The resistance R2 represents the passage 15 between the cold air damper 4 and the warm air damper 5, represented in FIGS. 3 and 5, and the resistance R6 represents the heating heat exchanger 7. The resistances R1 and R3 represent the passages 11 and 12 through the cold air damper 4, and the resistances R4 and R5 correspond to the passages 13 and 14 through the warm air damper 5.

In a 50% warm setting, a classic basis for optimizing linearity is a ratio of resistances over the cold air damper 4 and the warm air damper 5 as follows: R_cold=x [Pa/(l/s)²] for the cold air passages 11, 12 and R_warm=˜2×[Pa/(l/s)²] for the passages 13, 14 through the warm air damper 5.

In the 50% warm setting and in the design of the control dampers according to the prior art, pressure decrease values of 52 Pa each, corresponding to y relative pressure Pa, are predefined for the resistances R1, R4 and R5, and a pressure decrease of 0.2 y relative pressure Pa is predefined for the resistance R3. If R2 is set to a lower value, then according to the simulation, the flow of the air through the heating heat exchanger 7 is approximately 0.24 l/s, thus the linearity is 24%.

At the same setting and in the design according to the invention, for a very small passage 15 between the cold air damper 4 and the warm air damper 5, the same values are predefined for the pressure decreases at the R1, R4, R5 and R3. If the resistance R2 is then set to a high value, this reduces the flow of the air through R2 to nearly 0 L/s and the flow rate through the heating heat exchanger 7 increases to 0.27 L/s, and thus a linearity of 27%.

The resulting increase in linearity is based on the fact that by increasing the resistance R2, the total resistance over the cold air damper 4 and the total resistance over the warm air damper 5 are adjusted. Linearity is thereby increased as compared with the initial situation, since in the initial situation, the resistance over the cold air damper 4 is lower than the resistance over the warm air damper 5, resulting in lower linearity.

A CFD calculation (Computational Field Dynamics) using a specific model according to FIG. 6c likewise results in the desired behavior.

The proportions of the geometries are set out below:

Cold Air Damper

| | |
|---|---|
| Length | a = 1.0 a |
| Distance (eccentric) | j = 0.0 a |
| Distance (in the damper plane) | e = 0.5 a |
| Gap between the cold air damper and a | f = 0.1 a |
| housing of the air conditioning system | |

Warm Air Damper

| | |
|---|---|
| Length | b = 0.9 a |
| Distance (eccentric) | h = 0.2 a |
| Distance (in the damper plane) | g = 0.4 a |
| Gap between the warm air damper and the | i = 0.4 a |
| housing of the air conditioning system | |

| | |
|---|---|
| Gap between axes (perpendicular to the | |
| main direction of the flow of the air) | d = 1.1 a |

If the gap c=0.3a, the linearity of the system at 50% warm is 50.5%. If the size of the gap c is decreased to 0.1a with the control dampers 4, 5 in the same angular position (50% warn damper position), the linearity increases to 52.4%.

A simple and cost-efficient design for improving the linearity of systems having at least the two control dampers 4, 5 has been presented. The positions of the cold air damper 4 and/or warm air damper 5 are designed in a novel configuration. These optimization measures significantly improve linearity at the examined 50% warm setting of the control dampers 4, 5 by 3%©.

### LIST OF REFERENCE SIGNS

1 motor vehicle air conditioning system
2 air flow to be treated
3 evaporator
4 cold air damper, control damper
5 warm air damper, control damper
6 rotational axis
7 heating heat exchanger, heating device
8 warm air flow
9 air outlet dampers
10 output air flow
11 upper passage through the cold air damper 4, cold air passage, arrow
12 lower passage through the cold air damper 4, cold air passage, arrow
13 upper passage through the warm air damper 5
14 lower passage through the warm air damper 5, arrow
15 passage between the cold air damper 4 and the warm air damper 5
16 baffle for narrowing the cross-section
17 damper disk
R1 flow resistance through the upper passage of the cold air damper
R2 flow resistance through the gap between the control dampers
R3 flow resistance through the lower passage of the cold air damper
R4 flow resistance through the upper passage of the warm air damper
R5 flow resistance through the lower passage of the warm air damper
R6 flow resistance through the heating device

1-7. (canceled)

8. A motor vehicle air conditioning system comprising:
a housing configured to receive a flow of air, the housing having a cold air path and a warm air path formed therein;
a cold air damper disposed in the housing and configured to control the flow of air through the cold air path; and
a warm air damper disposed in the housing and configured to control the flow of air through the warm air path, the warm air damper cooperating with the cold air damper to form a passage therebetween, the passage configured to receive a portion of the flow of air to maximize linearity of an amount of the flow of air through the cold air path to an amount of the air flow through the warm air path.

9. The motor vehicle air conditioning system of claim 8, wherein the cold air damper has a substantially planar cross-sectional shape.

10. The motor vehicle air conditioning system of claim 8, wherein the warm air damper has a substantially non-planar cross-sectional shape.

11. The motor vehicle air conditioning system of claim 8, wherein the cold air damper rotates about a rotational axis extending therethrough and the warm air damper rotates about a rotational axis extending therethrough, the rotational axis of the cold air damper and the rotational axis of the warm air damper extending perpendicular to a direction of the flow of air through the housing.

12. The motor vehicle air conditioning system of claim 11, wherein the rotational axis of the cold air damper extends through the cold air damper at distance from a center of the cold air damper with respect to a length of the cold air damper.

13. The motor vehicle air conditioning system of claim 12, wherein the cold air damper is configured to divide the cold air path into an upper passage and a lower passage, wherein the upper passage has a length greater than a length of the lower passage.

14. The motor vehicle air conditioning system of claim 11, wherein the warm air damper includes a substantially planar damper disk, and wherein the rotational axis of the warm air damper extends parallel to and at a distance from the damper disk.

15. The motor vehicle air conditioning system of claim 11, wherein the warm air damper includes a substantially planar damper disk, the rotational axis extending coplanar with the damper disk at a distance from a center of the damper disk with respect to a length of the damper disk.

16. The motor vehicle air conditioning system of claim 11, wherein the cold air damper includes a substantially planar damper disk, and wherein the rotational axis of the cold air damper extends parallel to and at a distance from the damper disk.

17. The motor vehicle air conditioning system of claim 11, wherein the cold air damper includes a substantially planar damper disk, the rotational axis extending coplanar with the damper disk at a distance from a center of the damper disk with respect to a length of the damper disk.

18. The motor vehicle air conditioning system of claim 11, wherein a width of the passage formed by the cold air damper and the warm air damper selectively increases and decreases with respect to a movement of the cold air damper about the rotational axis of the cold air damper and a movement of the warm air damper about the rotational axis of the warm air damper.

19. The motor vehicle air conditioning system of claim 18, wherein an air resistance of the passage is maximized during a 50% warm setting of the motor vehicle air conditioning system.
